(19) United States
(12) Patent Application Publication
(10) Pub. No.: US 2019/0350027 A1
(43) Pub. Date: Nov. 14, 2019

(54) A Radio Access Node, a Core Network Node, an Information Database and Methods of Operating the Same

(71) Applicant: Telefonaktiebolaget LM Ericsson (publ), Stockholm (SE)

(72) Inventors: Angelo Centonza, Stockholm (SE); Paul Schliwa-Bertling, Ljungsbro (SE); Jari Vikberg, Järna (SE)

(21) Appl. No.: 15/750,869

(22) PCT Filed: Dec. 12, 2017
(86) PCT No.: PCT/SE2017/051251

§ 371 Date: Feb. 7, 2018

Related U.S. Application Data
(60) Provisional application No. 62/444,943, filed on Jan. 11, 2017.

(51) Int. Cl. H04W 76/16; H04W 88/06; H04W 8/24; H04W 48/16; H04W 76/25

(52) U.S. Cl. CPC H04W 76/16; H04W 88/06; H04W 76/25; H04W 48/16; H04W 8/24

(57) ABSTRACT

According to an aspect, there is provided a method of operating a first radio access node, wherein the first radio access node uses a first radio access technology, RAT, to communicate with terminal devices. The method comprises receiving (201) capability information for a first terminal device, the capability information indicating whether the first terminal device is capable of using dual connectivity with the first RAT and a second, different, RAT; receiving (203) permission information, the permission information indicating whether the first terminal device is permitted to use dual connectivity with the first RAT and the second RAT; and determining (205) whether to activate dual connectivity with the first RAT and the second RAT for the first terminal device based on the received capability information and received permission information. Other aspects include methods of operating a core network node and an information database as well as radio access nodes, core network nodes and information data bases.

### TECHNICAL FIELD

This disclosure relates to radio access nodes operating according to different radio access technologies and to core network nodes and information databases for use with such radio access nodes.

### BACKGROUND

The Third Generation Partnership Project (3GPP) is currently in the process of specifying a new radio interface that is to provide better performance than currently available technologies such as Long Term Evolution (LTE) and LTE-Advanced. This new radio interface, or radio access technology (RAT), is currently referred to as New Radio (NR). 3GPP are also in the process of defining a new core network (CN) to accompany the new radio interface. This new core network is currently referred to as 5G (5^{th} Generation) CN or the Next Generation Packet Core Network (NG-CN or NGC). A high level architectural view of the new radio interface and core network is provided in 3GPP TS 23.799 v14.0.0, particularly section 4.2.1.

To timely match the market demands for introduction of the new 5G system, 3GPP has agreed on several connectivity/deployment options by which the New Radio (NR) RAT can be implemented. The different connectivity options depend on which core network is used (e.g. the Evolved Packet Core (EPC) or NG-CN/NGC) and which type of RATs are to be used (e.g. LTE and/or NR).

The connectivity options of interest in this disclosure are shown in FIGS. 1 and 2. Both figures show a radio or wireless terminal (also known as a mobile station, user equipment unit (UE) and/or a terminal device) 2, an LTE radio access node, known as an eNodeB or eNB 4, a NR radio access node 6, which in some cases is referred to as a gNB, and an EPC 8.

The connectivity options shown in FIGS. 1 and 2 are referred to as “non-standalone LTE/NR” or “LTE assisted”, and are based on the UE 2 being served by the LTE EPC 8 being provided with control plane data (e.g. EPC Non-Access Stratum (NAS) signalling) via the LTE radio access network (known as the Evolved UTRA (Universal Mobile Telecommunications Service (UMTS) Terrestrial Radio Access) Network (E-UTRAN)), i.e. via the eNB 4 and the Uu interface, so that the UE 2 is ‘anchored’ in LTE. The UE 2 can operate in a so-called ‘dual connectivity’ mode in which the UE 2 can transmit data and/or receive data simultaneously using both the LTE RAT (i.e. via eNB 4) and the NR RAT (i.e. via gNB 6). The NR RAT is used for user-plane data only. In both FIGS. 1 and 2, the eNB 4 has control plane and user plane connections (referred to as S1-MME and S1-U respectively) with the EPC 8. In FIG. 1, the gNB 6 has a user plane interface to the eNB 4, but not to the EPC 8. In FIG. 2, the gNB 6 has a user plane interface to both the eNB 4 and the EPC 8. These connectivity options are defined in 3GPP TR 23.799 v2.0.0, Annex J.3.

### SUMMARY

The connectivity options shown in FIGS. 1 and 2 make use of the Dual Connectivity (DC) function defined in LTE in which a UE can utilise radio resources (i.e. to send and/or receive data) provided by two distinct schedulers, i.e. by two separate eNBs. Typically, an eNB decides whether to activate DC for a UE based on information that indicates whether the UE is capable of using DC.

In applying DC to LTE and NR deployments, it has been found that the conventional DC mechanisms defined in LTE do not provide the network operator (i.e. the operator of the network(s) providing the LTE and/or NR access) with enough control over whether a UE is to use DC with LTE and NR. In particular, an eNB can decide to activate DC for any UE that is capable of using DC.

Therefore, there is a need for improved techniques for controlling whether a UE, or more generally a terminal device, can use dual connectivity with an LTE radio access node and a NR radio access node, or more generally with radio access nodes that use any two different radio access technologies.

According to a first aspect, there is provided a method of operating a first radio access node, wherein the first radio access node uses a first radio access technology, RAT, to communicate with terminal devices. The method comprises receiving capability information for a first terminal device, the capability information indicating whether the first terminal device is capable of using dual connectivity with the first RAT and a second, different, RAT; receiving permission information, the permission information indicating whether the first terminal device is permitted to use dual connectivity with the first RAT and the second RAT; and determining whether to activate dual connectivity with the first RAT and the second RAT for the first terminal device based on the received capability information and received permission information.

According to a second aspect, there is provided a method of operating a core network node. The method comprises receiving permission information from an information database, the permission information indicating whether a first terminal device is permitted to use dual connectivity with a first radio access technology, RAT, and a second, different, RAT; and sending the permission information to a first radio access node that uses the first RAT.

According to a third aspect, there is provided a method of operating an information database. The method comprises storing permission information for at least a first terminal device, the permission information indicating whether a first terminal device is permitted to use dual connectivity with a first radio access technology, RAT, and a second, different, RAT; and sending the permission information to a core network node.

According to a fourth aspect, there is provided a first radio access node, the first radio access node is adapted or configured to use a first radio access technology, RAT, to communicate with terminal devices. The first radio access node is adapted or configured to receive capability information for a first terminal device, the capability information indicating whether the first terminal device is capable of using dual connectivity with the first RAT and a second, different, RAT; receive permission information, the permission information indicating whether the first terminal device is permitted to use dual connectivity with the first RAT and the second RAT; and determine whether to activate dual connectivity with the first RAT and the second RAT for the first terminal device based on the received capability information and received permission information.

According to a fifth aspect, there is provided a core network node. The core network node is adapted or configured to receive permission information from an information database, the permission information indicating whether a first terminal device is permitted to use dual connectivity with a first radio access technology, RAT, and a second, different, RAT; and send the permission information to a first radio access node that uses the first RAT.

According to a sixth aspect, there is provided an information database. The information database is adapted or configured to store permission information for at least a first terminal device, the permission information indicating whether a first terminal device is permitted to use dual connectivity with a first radio access technology, RAT, and a second, different, RAT; and send the permission information to a core network node.

According to a seventh aspect, there is provided a computer program product comprising a computer readable medium having computer readable code embodied therein, the computer readable code being configured such that, on execution by a suitable computer or processor, the computer or processor is caused to perform any of the methods described herein.

According to an eighth aspect, there is provided a first radio access node, the first radio access node configured to use a first radio access technology, RAT, to communicate with terminal devices. The first radio access node comprises a processor and a memory, said memory containing instructions executable by said processor, whereby said first radio access node is operative to receive capability information for a first terminal device, the capability information indicating whether the first terminal device is capable of using dual connectivity with the first RAT and a second, different, RAT; receive permission information, the permission information indicating whether the first terminal device is permitted to use dual connectivity with the first RAT and the second RAT; and determine whether to activate dual connectivity with the first RAT and the second RAT for the first terminal device based on the received capability information and received permission information.

According to a ninth aspect, there is provided a core network node. The core network node comprises a processor and a memory, said memory containing instructions executable by said processor, whereby said core network node is operative to receive permission information from an information database, the permission information indicating whether a first terminal device is permitted to use dual connectivity with a first radio access technology, RAT, and a second, different, RAT; and send the permission information to a first radio access node that uses the first RAT.

According to a tenth aspect, there is provided an information database. The information database comprises a processor and a memory, said memory containing instructions executable by said processor, whereby said information database is operative to store permission information for at least a first terminal device, the permission information indicating whether a first terminal device is permitted to use dual connectivity with a first radio access technology, RAT, and a second, different, RAT; and send the permission information to a core network node.

### BRIEF DESCRIPTION OF THE DRAWINGS

Exemplary embodiments of the techniques introduced in this document are described below with reference to the following figures, in which:

FIG. 1 shows a first connectivity option for LTE and NR;

FIG. 2 shows a second connectivity option for LTE and NR;

FIG. 3 is a non-limiting example block diagram of a LTE network;

FIG. 4 is a block diagram of a radio access node according to an embodiment:

FIG. 5 is a block diagram of a core network node according to an embodiment;

FIG. 6 is a block diagram of an information database according to an embodiment;

FIG. 7 is a signalling diagram illustrating an S1 Setup procedure on S1AP;

FIG. 8 is a signalling diagram illustrating an Initial Context Setup procedure on S1AP;

FIG. 9 is a signalling diagram illustrating an UE Capability Enquiry procedure;

FIG. 10 is an illustration of a radio protocol architecture for Dual Connectivity;

FIG. 11 is an illustration of control plane connectivity of eNBs in Dual Connectivity;

FIG. 12 is an illustration of user plane connectivity of eNBs in Dual Connectivity;

FIG. 13 is an illustration of the bearer options for the Dual Connectivity shown in FIGS. 1 and 2;

FIG. 14 is a signalling diagram illustrating an exemplary embodiment;

FIG. 15 is a flow chart illustrating a method of operating a radio access node according to an embodiment;

FIG. 16 is a flow chart illustrating a method of operating a core network node according to an embodiment; and

FIG. 17 is a flow chart illustrating a method of operating an information database according to an embodiment.

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing units, one or more processing modules or one or more controllers, and the terms computer, processor, processing unit, processing module and controller may be employed interchangeably. When provided by a computer, processor, processing unit, processing module or controller, the functions may be provided by a single dedicated computer, processor, processing unit, processing module or controller, by a single shared computer, processor, processing unit, processing module or controller, or by a plurality of individual computers, processors, processing units, processing modules or controllers, some of which may be shared or distributed. Moreover, these terms also refer to other hardware capable of performing such functions and/or executing software, such as the example hardware recited above.

Although in the description below the term user equipment (UE) is used, it should be understood by the skilled in the art that “UE” is a non-limiting term comprising any mobile or wireless device or node equipped with a radio interface allowing for at least one of: transmitting signals in uplink (UL) and receiving and/or measuring signals in downlink (DL). A UE herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “UE”, the terms “mobile device” and “terminal device” may be used interchangeably in the following description, and it will be appreciated that such a device does not necessarily have to be ‘mobile’ in the sense that it is carried by a user. Instead, the terms “mobile device” and “terminal device” encompass any device that is capable of communicating with communication networks that operate according to one or more mobile communication standards, such as the Global System for Mobile communications, GSM, Universal Mobile Telecommunications System (UMTS), Wideband Code-Division Multiple Access (WCDMA), Long-Term Evolution (LTE), New Radio (NR), etc.

A cell is associated with a base station, where a base station comprises in a general sense any network node transmitting radio signals in the downlink and/or receiving radio signals in the uplink. Some example base stations, or terms used for describing base stations, are eNodeB, eNB, NodeB, gNB, Wireless Local Area Network (WLAN) AP, macro/micro/pico/femto radio base station, home eNodeB (also known as femto base station), relay, repeater, sensor, transmitting-only radio nodes or receiving-only radio nodes. A base station may operate or at least perform measurements in one or more frequencies, carrier frequencies or frequency bands and may be capable of carrier aggregation. It may also be a single-radio access technology (RAT), multi-RAT, or multi-standard node, e.g., using the same or different base band modules for different RATs.

It should be noted that the term “radio access node” as used herein can refer to a base station, such as an eNodeB, a gNB or a WLAN AP, or a network node in the radio access network (RAN) responsible for resource management, such as a radio network controller (RNC).

Unless otherwise indicated herein, the signalling described is either via direct links or logical links (e.g. via higher layer protocols and/or via one or more network nodes).

Although the techniques presented herein are described with reference to dual connectivity with LTE and NR RATs, with the control of the dual connectivity being provided by the LTE network, it will be appreciated that control of the dual connectivity could alternatively be provided by the NR network. In addition it will be appreciated that the techniques are also applicable to dual connectivity with radio access technologies other than LTE and/or NR.

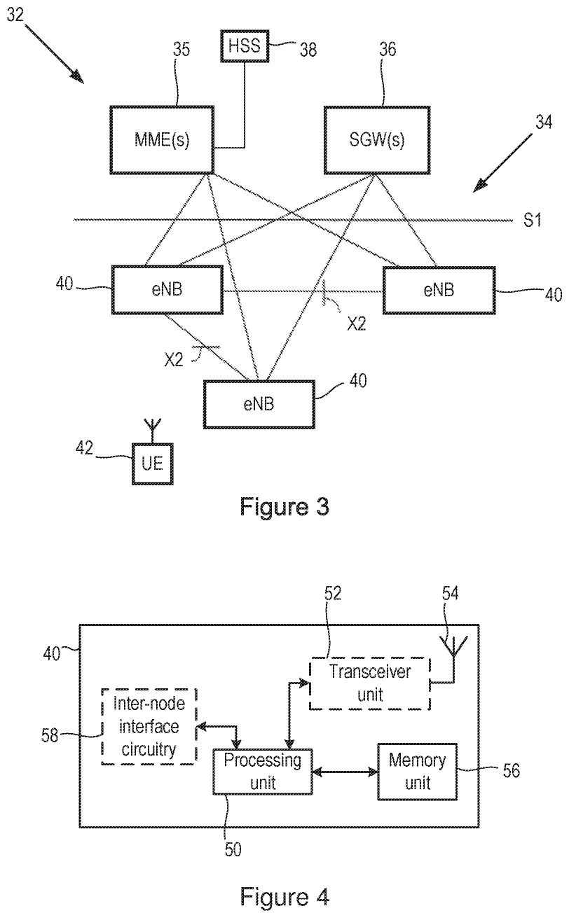

FIG. 3 shows an example diagram of an evolved UMTS Terrestrial Radio Access Network (E-UTRAN) architecture as part of an LTE-based communications system 32 to which the techniques described herein can be applied. Nodes in a core network (CN) 34 part of the system 32 include one or more Mobility Management Entities (MMEs) 35 (which can also be referred to as Mobility Management Functions (MMFs) or Access and Mobility Management Functions (AMFs)), a key control node for the LTE access network, and one or more Serving Gateways (SGWs) 36 which route and forward user data packets while acting as a mobility anchor. A Home Subscriber Server (HSS) 38 is also provided in the CN 34 that is connected to the MMEs 35, and the HSS 38 stores and maintains a database of user subscription information, including user identities (e.g. the IMSI (International Mobile Subscriber Identity) and MSISDN (Mobile Subscriber Integrated Services Digital Network (ISDN) Number) or mobile telephone number), user profile information (such as service subscription states and quality of service (QoS) information and user security information). The MMEs 35 and SGWs 36 communicate with base stations or radio access nodes 40 referred to in LTE as eNBs, over an interface, for example an S1 interface. The eNBs 40 can include the same or different categories of eNBs, e.g. macro eNBs, and/or micro/pico/femto eNBs. The eNBs 40 communicate with each other over an inter-node interface, for example an X2 interface. The S1 interface and X2 interface are defined in the LTE standard. A UE 42 is shown, and a UE 42 can receive downlink data from and send uplink data to one of the base stations 40, with that base station 40 being referred to as the serving base station of the UE 42.

The eNBs 40 in the E-UTRAN provide the E-UTRA user plane (e.g. Packet Data Convergence Protocol (PDCP)/Radio Link Control (RLC)/Medium Access Control (MAC)/Physical layer (PHY)) and control plane (e.g. Radio Resource Control (RRC) in addition to the user plane protocols) protocol terminations towards the UEs 42.

FIG. 4 shows a radio access node 40 that can be adapted or configured to operate according to one or more of the non-limiting example embodiments described. The radio access node 40 can be a node such as an eNB, or gNB.

The radio access node 40 comprises a processor or processing unit 50 that controls the operation of the node 40. The processing unit 50 is connected to a transceiver unit 52 (which comprises a receiver and a transmitter) with associated antenna(s) 54 which are used to transmit signals to and receive signals from terminal devices 42, such as UEs. In some embodiments, the processing unit 50 can comprise one or more modules for implementing individual processing steps of the techniques described herein. The transceiver unit 52 can be configured or adapted to operate according to one or more radio access technologies (RATs), such as LTE or NR.

The radio access node 40 also comprises a memory or memory unit 56 that is connected to the processing unit 50 and that contains instructions or computer code executable by the processing unit 50 and other information or data required for the operation of the node 40.

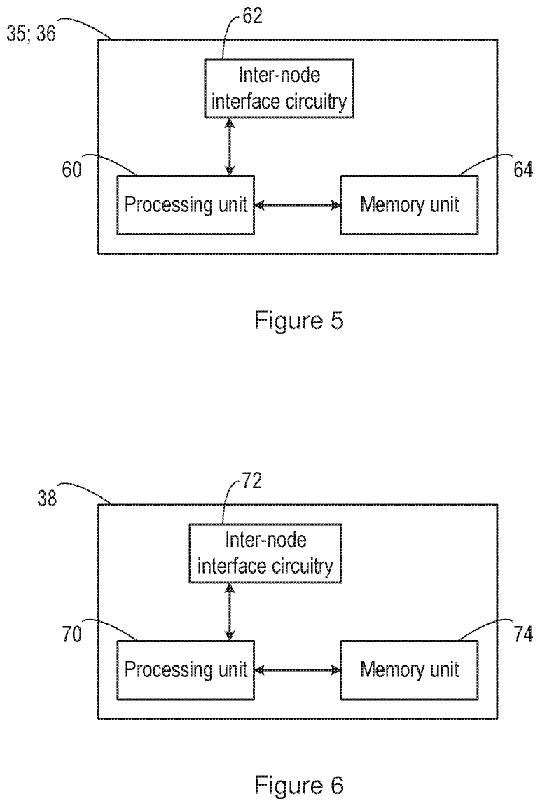

The radio access node 40 also includes components and/or circuitry 58 for allowing the radio access node 40 to exchange information with one or more core network nodes, such as an MME 35 and SGW 36 (e.g. via the S1-U and S1-MME interfaces in LTE). FIG. 5 shows a core network node 35, 36 that can be adapted or configured to operate according to one or more of the non-limiting example embodiments described. The core network node 40 can be a node such as an MME/MMF/AMF 35 or SGW 36.

The core network node 35, 36 comprises a processor or processing unit 60 that controls the operation of the core network node 35, 36. In some embodiments, the processing unit 60 can comprise one or more modules for implementing individual processing steps of the techniques described herein. The processing unit 60 is connected to components and/or circuitry 62 for allowing the core network node 35, 36 to exchange information with one or more radio access nodes 40, such as eNBs 40 and/or NR radio access nodes (e.g. gNBs), for example via the S1-U and S1-MME interfaces in LTE. The components and/or circuitry 62 may also allow the core network node 35, 36 to receive and/or exchange information with an information database 38, such as an HSS. The core network node 35, 36 also comprises a memory or memory unit 64 that is connected to the processing unit 60 and that contains instructions or computer code executable by the processing unit 60 and other information or data required for the operation of the core network node 35, 36.

FIG. 6 shows an information database 38 that can be adapted or configured to operate according to one or more of the non-limiting example embodiments described. The information database 38 can be a node such as an HSS 38 in an LTE network.

The information database 38 comprises a processor or processing unit 70 that controls the operation of the information database 38. In some embodiments, the processing unit 70 can comprise one or more modules for implementing individual processing steps of the techniques described herein. The processing unit 70 is connected to components and/or circuitry 72 for allowing the information database 38 to send information to and/or exchange information with one or more core network nodes 35, 36 (such as MME(s) 35), for example via the S6a interface in LTE. The information database 38 also comprises a memory or memory unit 74 that is connected to the processing unit 70 and that contains or stores information on the terminal devices 42 in the network 32. For example the memory unit 74 can store a database of user subscription information, including user identities (e.g. the IMSI, MSISDN and/or mobile telephone number), user profile information (such as service subscription states and QoS information and user security information. The memory unit 74 can also contain instructions or computer code executable by the processing unit 70 and other information or data required for the operation of the information database 38.

It will be appreciated that only the components of the radio access node 40, core network node 35, 36 and information database 38 required to explain the embodiments presented herein are illustrated in FIGS. 4, 5 and 6.

To facilitate the discussion of the use of dual connectivity (DC) with LTE and NR/5G provided herein, various aspects of existing LTE networks are described below.

In LTE, the S1-MME interface is used for the control plane between eNBs/E-UTRAN and the MME 35. The main protocols used in this interface are the S1 Application Protocol (S1-AP) and Stream Control Transmission Protocol (SCTP). S1AP is the application Layer Protocol between the eNodeB 40 and the MME 35, and SCTP, for example, guarantees delivery of signalling messages between the MME 35 and eNodeB 40. The transport network layer is based on Internet Protocol (IP).

A subset of the S1 interface provided functions are:
S1-interface management functions such as S1 setup, error indication, reset and eNB and MME configuration update.
UE Context Management functionality such as Initial Context Setup Function and UE Context Modification Function.
E-RAB (E-UTRAN Radio Access Bearer) Service Management function (Setup, Modify, Release).
Mobility Functions for UEs in ECM-CONNECTED (Intra-LTE Handover and inter-3GPP-RAT Handover).
S1 Paging function.
NAS Signalling Transport function.

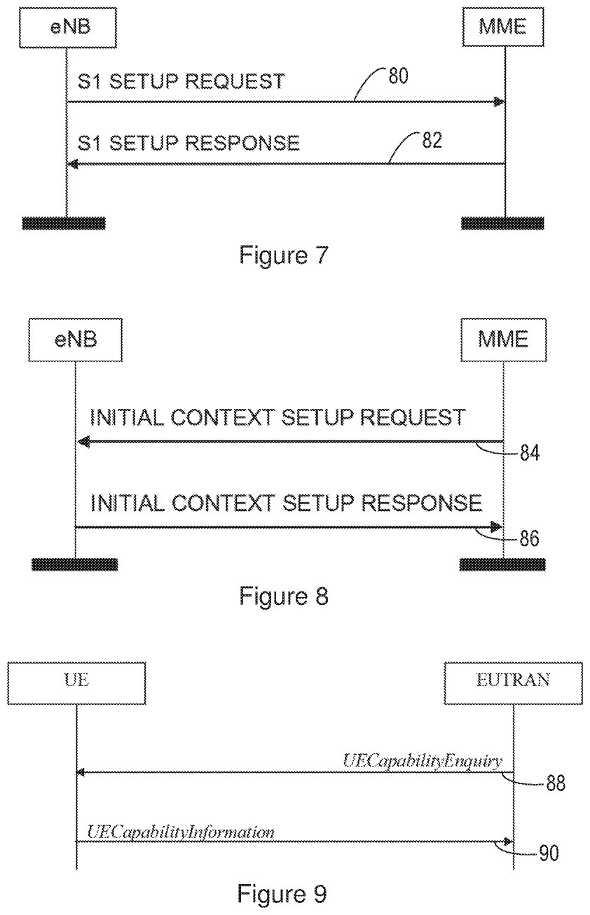

The S1 setup procedure used to establish the S1-MME interface on the S1AP protocol level is shown in FIG. 7. The purpose of the S1 Setup procedure is to exchange application level data needed for the eNB 40 and the MME 35 to correctly interoperate on the S1 interface. The eNB 40 may initiate the procedure by sending the S1 SETUP REQUEST message 80 to the MME 35 once it has gained IP connectivity and it has been configured with at least one Tracking Area Identity (TAI). The TAI(s) are used by the eNB 40 to locate IP-addresses of the different MMEs (possibly in different MME pools). The eNB 40 includes its global eNB identity and other information in the S1 SETUP REQUEST message 80. The MME responds with the S1 SETUP RESPONSE message 82. This message 82 includes, for example, the Globally Unique MME identifier(s) (GUMMEI) of the MME 35.

FIG. 8 shows the signalling between an eNB 40 and MME 35 to setup a UE context in LTE, known as the Initial Context Setup. The INITIAL CONTEXT SETUP REQUEST message 84 is sent by the MME 35 to eNB 40 to request the setup of a UE context. This message 84 contains information related to both the UE context and the different E-RABs to be established. For each E-RAB the MME 35 includes E-RAB QoS parameters such as QoS Class Identifier (QCI) and Allocation and Retention Priority (ARP). The QCI is a scalar that is used as a reference to access node-specific parameters that control bearer level packet forwarding treatment (e.g. scheduling weights, admission thresholds, queue management thresholds, link layer protocol configuration, etc.), and that have been pre-configured by the operator owning the access node (e.g. eNodeB).

To support different scenarios, which may call for different terminal device capabilities in terms of data rates, as well as to allow for market differentiation in terms of low- and high-end terminal devices with a corresponding difference in price, not all terminal devices support all capabilities. Furthermore, terminal devices from an earlier release of the LTE standards will not support features introduced in later versions of LTE. For example, a 3GPP Rel-8 (Release 8) terminal device will not support carrier aggregation as this feature was first introduced in 3GPP Rel-10. Therefore, in LTE, as part of the connection setup, the terminal device indicates not only which release of LTE it supports, but also its capabilities within the release (for example specifically which features it is capable of using).

The different UE capabilities can be divided into Radio or Access Stratum (AS), and Core Network or Non-Access-Stratum (NAS) information. RRC signalling is used to carry AS capabilities from the UE 42 to the eNB 40 and NAS signalling is used to carry NAS capabilities from the UE 42 to the MME 35. The UE capability information is stored in the MME 35.

The UE radio (or AS) capability information contains information on RATs that the UE 42 supports (e.g. power class, frequency bands, etc.). Consequently, this information can be relatively large and it is undesirable to send it across the radio interface at every transition from idle to active/connected. In addition, the retrieval of UE radio capability information at every idle to active/connected transition would delay the establishment of the user plane connectivity. To avoid these overheads related to the radio interface, the MME 35 stores the UE radio capability information when the UE 42 is in the idle state and the MME 35 can send the UE radio capability information to the eNB/E UTRAN in the S1 interface INITIAL CONTEXT SETUP REQUEST message 84. The MME 35 may also ask the eNB 40 to retrieve the UE radio capability information from the UE 42 for example depending on the reason of the service request (e.g. if Attach was performed). In the uplink, no capability information is sent early in, for example, an RRCConnectionRequest message. The UE capability enquiry procedure is a separate procedure and can be triggered from the eNB 40 (EUTRAN) to retrieve the UE radio capabilities as shown in FIG. 9. Thus, the eNB 40/E-UTRAN can send a UECapabilityEnquiry message 88 to the UE 42, and the UE 42 can respond with the capability information contained in a UECapabilityInformation message 90.

The UE Core Network Capability is split into the UE Network Capability Information Element (IE) (mostly for E-UTRAN access related core network parameters) and the MS (Mobile Station) Network Capability IE (mostly for UTRAN/GERAN access related core network parameters) and contains non radio-related capabilities, e.g. the NAS security algorithms etc. Both the UE Network Capability and the MS Network Capability are transferred between CN nodes at MME to MME, MME to SGSN (Serving GPRS (General Packet Radio Service) Support Node), SGSN to SGSN, and SGSN to MME changes. The UE 42 sends the UE Core Network Capability information to the MME 35 for example during Attach and non-periodic Tracking Area Update procedures.

LTE Dual Connectivity (DC) is a solution standardised in 3GPP Rel-12 to support UEs connecting to multiple carriers to send/receive data on multiple carriers at the same time. Some details of DC are provided below, but further detail can be found in 3GPP TS 36.300 v14.1.0.

E-UTRAN supports Dual Connectivity (DC) operation whereby a multiple receiver (Rx)/transmitter (Tx) UE 42 in RRC_CONNECTED mode is configured to utilise radio resources provided by two distinct schedulers, located in two eNBs 42 connected via a non-ideal backhaul over the X2 interface (see 3GPP TR 36.842 v12.0.0 and 3GPP TR 36.932 v13.0.0). The overall E-UTRAN architecture shown in FIG. 3 is applicable to DC. eNBs 40 involved in DC for a certain UE 42 may assume two different roles: an eNB 40 may either act as a Master eNB (MeNB) or as a Secondary eNB (SeNB). In DC a UE 42 is connected to one MeNB and one SeNB.

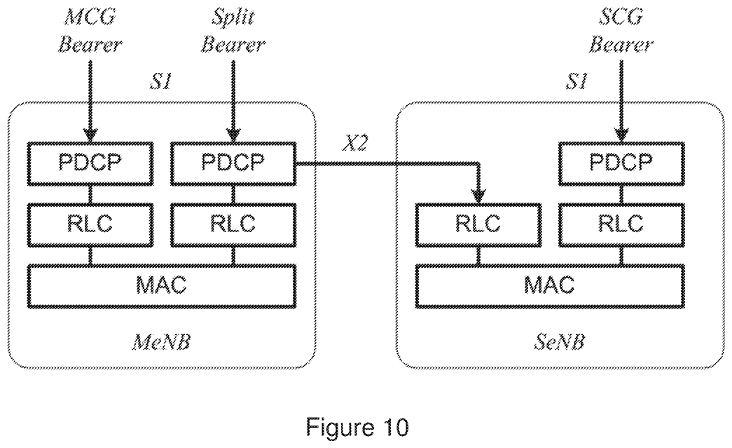

In DC, the radio protocol architecture that a particular bearer uses depends on how the bearer is setup. Three bearer types exist: MCG (Master Cell Group) bearer, SCG (Secondary Cell Group) bearer and split bearer. Those three bearer types are depicted in FIG. 10. RRC is located in the MeNB and Signalling Radio Bearers (SRBs) are always configured as MCG bearer type and therefore only use the radio resources of the MeNB. A UE 42 that is using DC can be described as having at least one bearer configured to use radio resources provided by the SeNB.

The inter-eNB control plane signalling for DC is performed by means of X2 interface signalling. Control plane signalling towards the MME 35 is performed by means of S1 interface signalling.

There is only one S1-MME connection per DC UE 42 between the MeNB and the MME 35. Each eNB 40 should be able to handle UEs independently, i.e. provide the PCell (Primary Cell) to some UEs while providing SCell(s) (Secondary Cells) for SCG to others. Each eNB 40 involved in DC for a certain UE 42 controls its radio resources and is primarily responsible for allocating radio resources of its cells. Respective coordination between MeNB and SeNB is performed by means of X2 interface signalling.

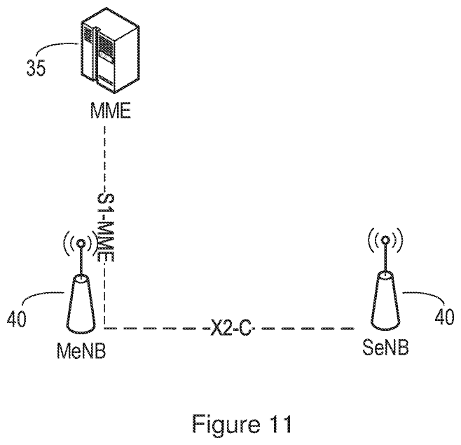

FIG. 11 shows control-plane (C-plane) connectivity of eNBs 40 involved in DC for a certain UE 42. In FIG. 11 the S1-MME interface from the MME 35 is terminated at the MeNB 40 and the MeNB 40 and the SeNB 40 are interconnected via the X2-C interface.

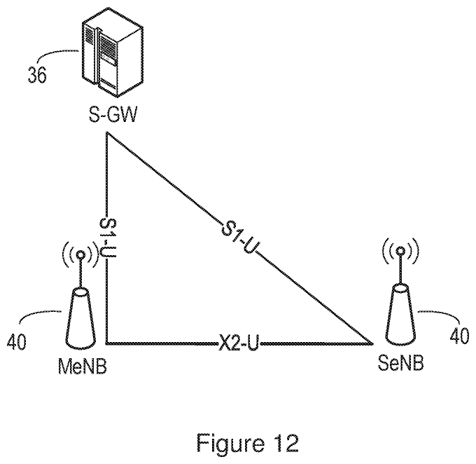

For dual connectivity two different user plane architectures are allowed: one architecture in which the S1-U only terminates in the MeNB and the user plane data is transferred from MeNB to SeNB using the X2-U, and a second architecture where the S1-U can terminate in the SeNB. FIG. 12 shows different user plane (U-plane) connectivity options of eNBs 40 involved in DC for a certain UE 42. Different bearer options can be configured with different user plane architectures. U-plane connectivity depends on the bearer option configured:
For MCG bearers, the S1-U connection for the corresponding bearer(s) to the S-GW 36 is terminated in the MeNB 40. The SeNB 40 is not involved in the transport of user plane data for this type of bearer(s) over the Uu interface.
For split bearers, the S1-U connection to the S-GW 36 is terminated in the MeNB 40. PDCP data is transferred between the MeNB 40 and the SeNB 40 via X2-U. The SeNB 40 and MeNB 40 are involved in transmitting data of this bearer type over the Uu interface.
For SCG bearers, the SeNB 40 is directly connected with the S-GW 36 via S1-U interface. The MeNB 40 is not involved in the transport of user plane data for this type of bearer(s) over the Uu interface.

The SeNB Addition procedure is initiated by the MeNB and is used to establish a UE context at the SeNB in order to provide radio resources from the SeNB to the UE. This procedure is used to add at least the first cell (Primary Secondary Cell, PSCell) of the SCG. The SeNB Addition procedure is described in 3GPP TS 36.300 v14.1.0 with reference to FIG. 10.1.2.8.1-1 of that document and will not be described further herein.

A Handover Restriction List (HRL) is an IE that is exchanged between CN and radio access network (RAN) nodes as well as between RAN nodes e.g. at mobility signalling. This IE currently contains a list of parameters such as Public Land Mobile Network Identifiers (PLMN ID) and Tracking Area Codes (TACs) that the UE is not permitted to access. Further the HRL contains a list of radio access technologies the UE cannot be handed over to. When the RAN (e.g. eNB) receives this IE either from the CN or from another RAN node, the RAN prevents the UE from either accessing or moving to any of the restricted technologies/networks/etc.

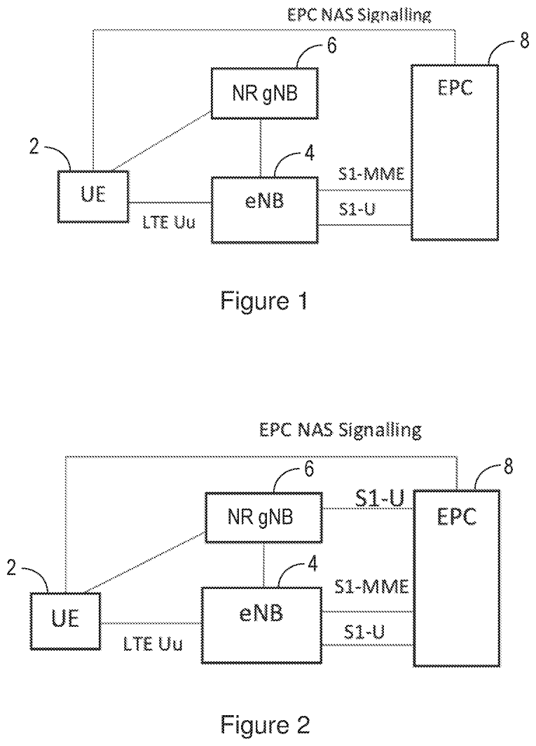

As noted above, FIGS. 1 and 2 show two possible connectivity options for implementing NR alongside LTE, in which the UE 42 is served by the CN based on EPC and control plane signalling is provided via the E-UTRAN, i.e. the UE is anchored in LTE, and a NR-RAT is added for user plane data only. Thus the UE 2 can operate in the Dual Connectivity mode with the UE 2 transmitting data and/or receiving data simultaneously using both the LTE RAT (i.e. via an eNB 40) and the NR RAT (i.e. via a gNB).

Also as noted above, in applying DC to LTE and NR deployments, it has been found that the conventional DC mechanisms defined in LTE do not provide the network operator (i.e. the operator of the network(s) providing the LTE and/or NR access) with enough control over whether a UE 42 is to use DC with LTE and NR. In particular, an eNB 40 can decide to activate DC for any UE 42 that is capable of using DC with an NR RAT.

Therefore, there is a need for improved techniques for controlling whether a UE, or more generally a terminal device, can use dual connectivity with an LTE radio access node and a NR radio access node, or more generally with radio access nodes that use any two different radio access technologies. It will be appreciated that dual connectivity within the meaning of this disclosure includes a mechanism by which a terminal device (UE) can transmit data to and/or receive data from two different radio access nodes that are operating according to or using different RATs, for example LTE and 5G/NR. Dual connectivity between two RATs can also be referred to as tight aggregation between the two RATs.

Briefly, the techniques described herein provide for control of the usage of NR RAT as a secondary access in Dual Connectivity with LTE. A network operator can configure in the HSS or other subscriber information database whether a UE is permitted or allowed to use a NR RAT, and this information can be provided to the RAN (e.g. eNB) in order to determine if NR RAT should be used as a secondary access. In some cases the UE can provide its radio capabilities to the LTE eNB in the normal way (e.g. as defined in the LTE standards), and the RAN decides if LTE-NR Dual Connectivity can be activated for the UE based on both the indication of whether NR RAT is allowed/permitted for the UE, which can be received from the CN, and the UE capabilities. Thus these techniques enable a network operator to control the usage of the dual connectivity deployments with E-UTRA as the anchor RAT and NR as the secondary RAT in a non-standalone configuration in an Evolved Packet System (EPS) for example based on the subscription information. This enables a network operator to have user subscriptions that are specific to 5G/NR in the connectivity options shown in FIGS. 1 and 2.

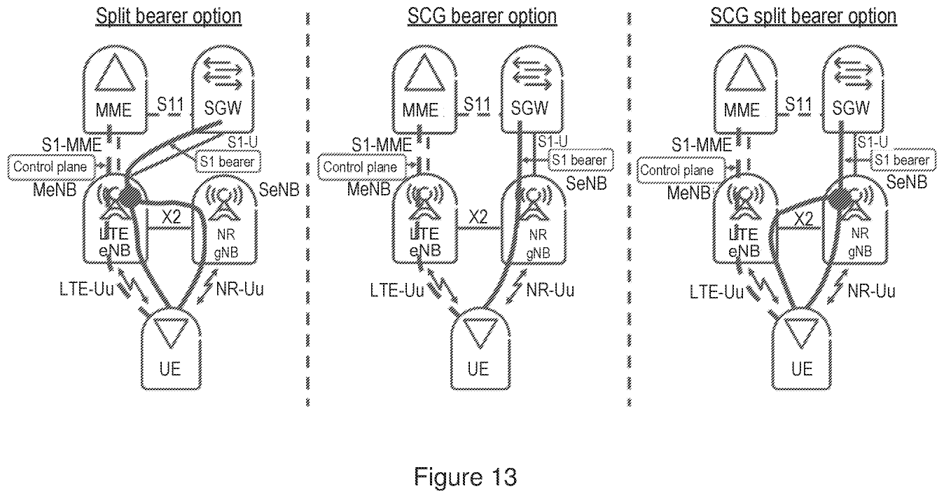

FIG. 13 shows the bearer options for the connectivity options shown in FIGS. 1 and 2. Thus FIG. 13 shows a split bearer option, an SCG bearer option and a SCG split bearer option. It should be noted that an MCG bearer option is not shown as it is not suitable for DC.

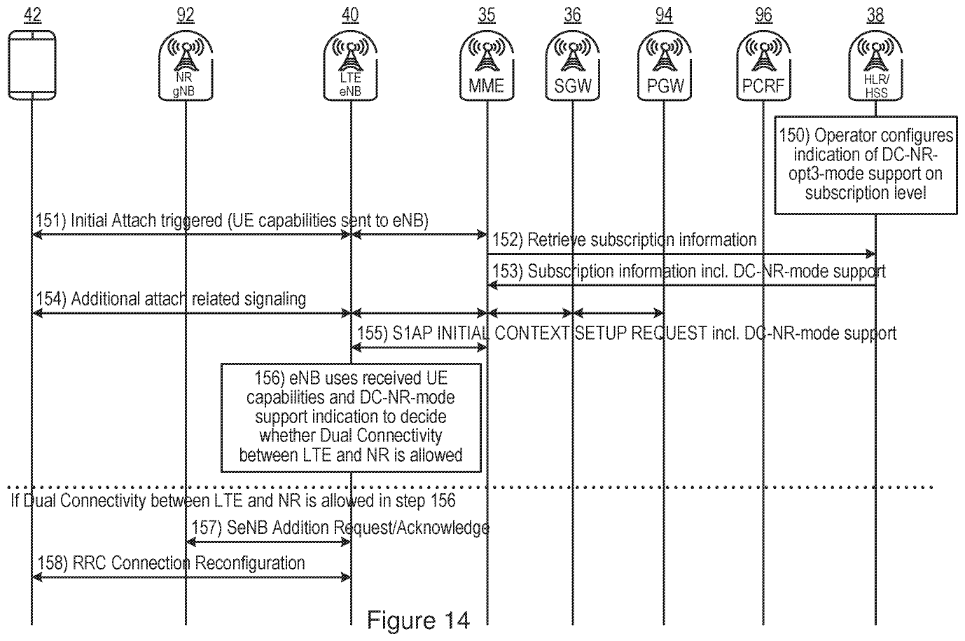

FIG. 14 is a signalling diagram showing an exemplary procedure for controlling the activation of dual connectivity with LTE and NR for a UE according to an embodiment. FIG. 14 shows the signalling between various nodes, including a HSS (or Home Location Register (HLR) or other information database) 38, an S-GW 36, an MME 35, an LTE eNB 40, a NR gNB 92 and a UE 42. A PDN (Packet Data Network) Gateway (P-GW) 94 and a Policy and Charging Rules Function (PCRF) 96 are also shown in FIG. 14.

The solution in FIG. 14 is based on several elements.

Firstly, the UE 42 includes the information about its support for the functionality required to operate in the DC configuration with one radio leg being NR-RAT based while anchored in LTE as per the deployments options shown in FIGS. 1 and 2. This connectivity mode is referred to herein as “DC-NR-mode”. It will be appreciated that the UE capability information can therefore indicate that the UE 42 does support (i.e. is capable of using) DC with NR and LTE, or does not support (i.e. is not capable of using) DC with NR and LTE. The capability information is referred to herein as “DC-NR-capability”. This information can be indicated by the UE 42, for example in the UE-EUTRA-Capability field (which is defined in 3GPP TS 36.331 v14.0.0 section 6.3.6) which can be conveyed to the MME 35 in the UE Radio Capability Information Element, which is defined in 3GPP TS 36.413 v14.0.0 section 9.2.1.27, similar to existing DC procedures.

In addition, the network operator can configure the subscriber database stored in the HSS 38 with permission information indicating whether a subscriber (e.g. a person) is eligible to operate their UE 42 in the DC configuration with one radio leg being NR-RAT based while anchored in LTE as per the deployment options shown in FIGS. 1 and 2 (DC-NR-mode). It will be appreciated that this permission information can indicate that the UE 42 is permitted to use DC with LTE and NR or not permitted to use DC with LTE and NR. This configuration of the permission information is shown as step 150 in FIG. 14, and it will be appreciated that this configuration can be performed when a subscriber joins (i.e. subscribes to) the network or changes their subscription level (e.g. adds or removes 5G/NR data).

At UE registration (e.g. when an Initial Attach is triggered between a UE 42 and MME 35), the UE 42 can send its capability information to the eNB 40. This is shown as step 151 in FIG. 14. The Initial Attach procedure also includes signalling between the eNB 40 and the MME 35 as shown in FIG. 14.

Also at UE registration (e.g. at Attach) the MME 35 requests information from the HSS 38 about the UE's subscription. This is shown as step 152 in FIG. 14. The HSS 38 provides the subscription information, including the permission information indicating whether the subscriber is eligible to operate its UE in the DC-NR-mode. This is shown as step 153.

Various additional (conventional) signalling occurs in step 154 of FIG. 14 to complete the Attach procedure.

Next, the MME 35 forwards the permission information indicating the subscriber's eligibility to operate their UE 42 in the DC-NR-mode to the eNB 40 that is serving the UE 42. This permission information can be sent via the S1 interface as part of the S1AP Initial Context Setup procedure or part of an S1AP handover procedure. In some cases the permission information can be sent to the eNB 40 in an S1-AP Initial Context Setup Request message (shown as step 155) or an S1-AP Handover Request message. In other cases, the permission information can be contained in a UE Context Modification Request message or a Downlink NAS Transport message.

In some cases, when a UE 42 is handed over from a source/serving eNB 40 to a target eNB 40, the source eNB 40 can forward the permission information previously received from the MME 35 to the target eNB 40 as part of the handover. For example the permission information can be included in the X2-AP Handover Request message when X2 Handover is triggered by the serving eNB 40.

When the eNB 40 serving the UE 42 receives the permission information about the subscriber's eligibility (permission) to operate its UE in the DC-NR-mode (which as noted above can be received via the S1 or X2 interface), the eNB 40 stores that information and uses it to determine whether the DC-NR-mode can be applied to the UE, taking the UE's capability information into consideration. This is shown as step 156. It will be appreciated that in practice the decision on whether the DC-NR-mode can be applied can also be based on measurement reports from the UE 42 for the NR RAT, and/or load information for one or both of the relevant nodes (eNB and gNB).

The eNB 40 can decide to apply or activate the DC-NR-mode only if the capability information indicates that the UE 42 is capable of using the DC-NR-mode and the permission information indicates that the UE 42 is permitted to use the DC-NR-mode. If the DC-NR-mode is to be activated, then the eNB 40 serving the UE 42 can configure the UE 42 and NR gNB to operate in the DC-NR-mode. This includes configuring the NR gNB as the secondary carrier, for example using the SeNB Addition Request procedure (indicated by step 157 in FIG. 14), and changing the configuration of the UE 42, for example using the RRC Connection Reconfiguration procedure (shown as step 158).

If at step 156 the eNB 40 determines that the subscriber is not eligible (i.e. not permitted) to use the DC-NR-mode based on the permission information received from the MME 35 over the S1 interface (or from a source eNB 40 over the X2 interface), then the eNB 40 can decide to not configure the UE 42 to operate in DC-NR-mode.

In some cases, an eNB 40 can realise that functionality by modifying the part of the capability information that indicates the UE's DC-NR-mode capability included in the UE Capability Info received from the MME 35 via the S1 interface e.g. in the S1-AP Initial Context Setup Request message. In any subsequent functions that evaluate the UE's radio configuration and that take UE's Radio Capability Information into account, the result will be that the UE is not considered to be capable of DC-NR-mode and thus the DC-NR-mode is not applicable.

As noted above, in step 155 the permission information can be received from the MME 35 over the S1-MME interface. There are different ways in which this indication can be provided including the following indicating the permission information as a separate information element (IE), indicating the permission information as part of the existing or an enhanced Handover Restriction List (HRL) IE, or indicating the permission information as part of existing or enhanced Subscriber Profile ID (SPID) IE.

In the case of the HRL, there are different ways to provide the information to the eNB 40. One way is to explicitly define a sub IE in the HRL that is used for DC purposes only and in particular for the use of indicating whether the DC-NR-mode is permitted or not permitted. This can be justified by the fact that a network operator may want to differentiate the use of DC-NR-mode from the use of NR access as a standalone access (i.e. independent of LTE). In fact, NR may be deployed as a standalone access in areas where there is no other RAT coverage. In this case not accessing NR would mean not being able to connect to any telecommunication system. On the other hand, the use of DC-NR-mode may provide an enhanced user experience and thus subject to a higher subscription charge for the user.

A different way to provide the information via HRL is to add the NR RAT to the list of “Forbidden inter RATs” when DC-NR-mode is not permitted. With this addition the UE might be prevented from accessing NR completely, both from a mobility point of view and from a DC point of view. In addition, the “Forbidden inter RATs” IE present in the HRL may be enhanced with the addition of multiple new values. Examples are as follows:
NR for Mobility: this new value would permit or prevent a UE from performing mobility to any NR radio access;
NR for DC: this new value would permit or prevent a UE from performing DC with any NR radio access;
NR: this new value would permit or prevent a UE from performing mobility to or DC with any NR radio access.

Given that according to conventional LTE mechanisms the HRL is already forwarded from a source eNB to a target eNB during mobility procedures, mobility target eNBs will be automatically updated about the restriction in using the DC-NR-mode for the UE in question.

Alternatively, during mobility procedures over the X2 interface (i.e. handover of a UE 42 from a source eNB 40 to a target eNB 40) the permission information on the use of the DC-NR-mode can be forwarded to the target eNodeB as part of the X2: Handover Request message. For mobility occurring via CN signalling, i.e. S1 based mobility, the permission information for the DC-NR-mode can be sent by the CN to the target eNB 40. In this way the target eNB 40 is always informed about the restriction in usage of the DC-NR-mode and can promptly allow appropriate UE configuration.

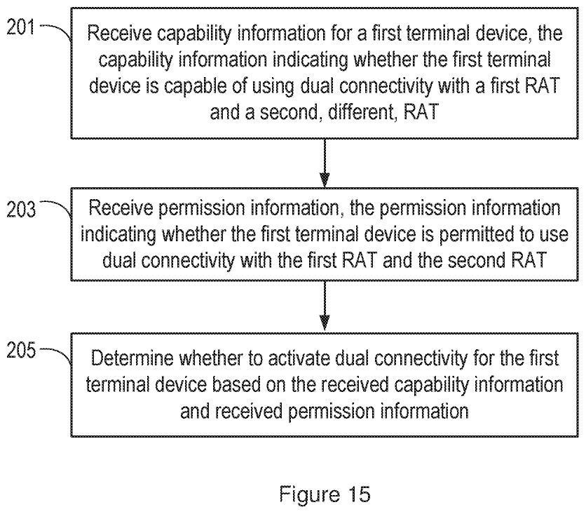

FIG. 15 shows a method of operating a first radio access node, such as an eNB 40, according to an exemplary embodiment. It will be appreciated that in some embodiments the processor or processing unit 50 can be configured or adapted to perform the method in FIG. 15. In some embodiments, the processor or processing unit 50 can be such that it is operable to perform the method in FIG. 15 when executing software stored in the memory unit 56.

The first radio access node 40 uses a first RAT to communicate with terminal devices 42. In a first step, step 201, the first radio access node 40 receives capability information for a first terminal device 42. The capability information indicates whether the first terminal device is capable of using dual connectivity with the first RAT and a second, different, RAT. In some embodiments, the first RAT is LTE. In some embodiments, the second RAT can be NR or another 5^{th} Generation RAT.

The first radio access node 40 also receives permission information (step 203). The permission information indicate whether the first terminal device is permitted to use dual connectivity with the first RAT and the second RAT. It will be appreciated that steps 201 and 203 do not have to occur in the order shown in FIG. 15, and in some cases the permission information can be received before or at the same time as the capability information is received.

Next, in step 205, the first radio access node 40 determines whether to activate dual connectivity with the first RAT and the second RAT for the first terminal device 42 based on the received capability information and received permission information.

In some embodiments, step 205 comprises determining that dual connectivity with the first RAT and the second RAT is to be activated for the first terminal device 42 if the capability information received in step 201 indicates that the first terminal device 42 is capable of using dual connectivity with the first RAT and the second RAT and the permission information received in step 203 indicates that the first terminal device 42 is permitted to use dual connectivity with the first RAT and the second RAT. Otherwise (i.e. if one or both of the capability information received in step 201 indicates that the first terminal device 42 is not capable of using dual connectivity with the first RAT and the second RAT or the permission information received in step 203 indicates that the first terminal device 42 is not permitted to use dual connectivity with the first RAT and the second RAT), then the first radio access node 40 can determine that dual connectivity with the first RAT and the second RAT is not to be activated for the first terminal device 42.

It will be appreciated that in some embodiments the first radio access node 40 can take into account additional information in the decision of step 205. For example the first radio access node 40 can also make use of measurement reports from the first terminal device 42 for the second RAT and/or load information for the two RATs.

In some embodiments, if dual connectivity with the first RAT and the second RAT is to be activated for the first terminal device 42, the method further comprises sending a first signal to a second radio access node that uses the second RAT (e.g. a gNB) to configure the second radio access node to communicate with the first terminal device 42. In some embodiments, the first signal is a SeNB Addition Request message.

In some embodiments, if dual connectivity with the first RAT and the second RAT is to be activated for the first terminal device 42, the method further comprises sending a second signal to the first terminal device 42 to configure the first terminal device 42 to use dual connectivity with the first radio access node 40 and the second radio access node. The second signal can be a RRC Connection message.

In some embodiments, if dual connectivity with the first RAT and the second RAT is not to be activated for the first terminal device 42, the method further comprises determining modified capability information for the first terminal device 42 indicating that the first terminal device 42 is not capable of using dual connectivity with the first RAT and the second RAT. This modified capability information can then be stored in the first radio access node 40.

In some embodiments, step 201 comprises receiving the capability information from the first terminal device 42. In other embodiments, step 201 can comprise receiving the capability information from a core network node, for example an MME, MMF or AMF 35.

In some embodiments, step 201 comprises receiving the capability information during an attachment procedure in which the first terminal device 42 attaches to the first radio access node. In these embodiments, the first radio access node 40 can receive the capability information from the first terminal device 42 in a UE-EUTRA-Capability field.

In some embodiments, the method can further comprise the step of sending the capability information to a core network node, for example an MME, MMF or AMF.

In some embodiments, step 203 comprises receiving the permission information from another network node, for example another radio access node using the first RAT (e.g. another eNB 40) or a core network node, e.g. an MME/MMF/AMF 35. In some embodiments, the permission information is received in one or more of an Initial Context Setup Request message, a UE Context Modification Request message, a Handover Request message and a Downlink NAS Transport message.

In some embodiments, step 203 comprises receiving the permission information in a list that indicates one or more parameters or restrictions for the first terminal device 42. The list can be a Handover Restriction List, HRL.

In other embodiments, step 203 comprises receiving the permission information in an information element, IE, for example a Subscriber Profile ID, SPID information element, IE.

Where the permission information is received from a core network node, the permission information can be received during an attachment procedure in which the first terminal device 42 attaches to the core network node 35.

Where the permission information is received from another radio access node 40, the permission information can be received during handover of the first terminal device 42 from the other radio access node 40 to the first radio access node 40.

In some embodiments, the method can also comprise the step of sending the permission information and/or the capability information to another (target) radio access node 40 that uses the first RAT on or during handover of the first terminal device 42 from the first radio access node 40 to the other (target) radio access node 40.

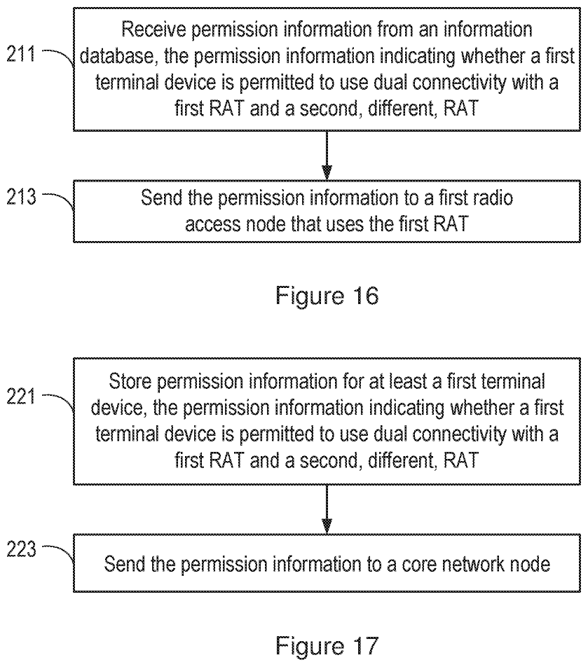

FIG. 16 shows a method of operating a core network node, such as an MME/MMF/AMF 35, according to an exemplary embodiment. It will be appreciated that in some embodiments the processor or processing unit 60 can be configured or adapted to perform the method in FIG. 16. In some embodiments, the processor or processing unit 60 can be such that it is operable to perform the method in FIG. 16 when executing software stored in the memory unit 64.

In a first step, step 211, the core network node 35 receives permission information from an information database 38, for example an HSS. The permission information indicates whether a first terminal device 42 is permitted to use dual connectivity with a first RAT (e.g. LTE), and a second, different, RAT (e.g. NR).

Next, in step 213, the core network node 35 sends the permission information to a first radio access node 40 (e.g. an eNB) that uses the first RAT.

In some embodiments, the permission information is sent to the first radio access node 40 in a list that indicates one or more parameters or restrictions for the first terminal device 42. This list can be a Handover Restriction List, HRL.

In other embodiments, the permission information can be sent to the first radio access node 40 in an information element, IE, for example a Subscriber Profile ID, SPID information element, IE. In other embodiments, the permission information can be sent to the first radio access 40 node in an Initial Context Setup Request message, a UE Context Modification Request message, a Downlink NAS Transport message or in a Handover Request message.

The permission information can be sent to the first radio access node 40 in step 211 during an attachment procedure in which the first terminal device 42 attaches to the core network node 35.

In some embodiments, the method further comprises the step of receiving capability information for the first terminal device 42 from the first radio access node 40. The capability information can indicate whether the first terminal device 42 is capable of using dual connectivity with the first RAT and the second RAT. The capability information can be contained in a UE Radio Capability IE.

In some embodiments, the method further comprises the step of sending capability information for the first terminal device 42 to the first radio access node 40, the capability information indicating whether the first terminal device 42 is capable of using dual connectivity with the first RAT and the second RAT.

FIG. 17 shows a method of operating an information database, such as an HSS 38, according to an exemplary embodiment. It will be appreciated that in some embodiments the processor or processing unit 70 can be configured or adapted to perform the method in FIG. 17. In some embodiments, the processor or processing unit 70 can be such that it is operable to perform the method in FIG. 17 when executing software stored in the memory unit 74.

In a first step, step 221, the method comprises storing permission information for at least a first terminal device 42, the permission information indicating whether a first terminal device 42 is permitted to use dual connectivity with a first RAT (e.g. LTE) and a second, different, RAT (e.g. NR).

In a subsequent step, step 223, the permission information is sent to a core network node, for example an MME/MMF/AMF 35.

In some embodiments, the permission information is set based on a subscription for the first terminal device 42 or based on a network operator preference.

Modifications and other variants of the described example(s) will come to mind to one skilled in the art having the benefit of the teachings presented in the foregoing descriptions and the associated drawings. Therefore, it is to be understood that the example(s) is/are not to be limited to the specific examples disclosed and that modifications and other variants are intended to be included within the scope of this disclosure. Although specific terms may be employed herein, they are used in a generic and descriptive sense only and not for purposes of limitation.

Various examples of the techniques described herein are set out in the following statements:

1. A method of operating a first radio access node, wherein the first radio access node uses a first radio access technology, RAT, to communicate with terminal devices, wherein the method comprises:
receiving capability information for a first terminal device, the capability information indicating whether the first terminal device is capable of using dual connectivity with the first RAT and a second, different, RAT;
receiving permission information, the permission information indicating whether the first terminal device is permitted to use dual connectivity with the first RAT and the second RAT; and
determining whether to activate dual connectivity with the first RAT and the second RAT for the first terminal device based on the received capability information and received permission information.

2. A method as defined in statement 1, wherein the step of determining comprises:
determining to activate dual connectivity with the first RAT and the second RAT for the first terminal device in the event that the received capability information indicates that the first terminal device is capable of using dual connectivity with the first RAT and the second RAT and the received permission information indicates that the first terminal device is permitted to use dual connectivity with the first RAT and the second RAT; and
otherwise determining that dual connectivity with the first RAT and the second RAT for the first terminal device is not to be activated.

3. A method as defined in statement 1 or 2, wherein the method further comprises the step of:
in the event that dual connectivity with the first RAT and the second RAT for the first terminal device is to be activated sending a first signal to a second radio access node that uses the second RAT to configure the second radio access node to communicate with the first terminal device.

4. A method as defined in statement 3, wherein the first signal comprises a SeNB Addition Request message.

5. A method as defined in any of statements 1-4, wherein the method further comprises the step of:
in the event that dual connectivity with the first RAT and the second RAT for the first terminal device is to be activated sending a second signal to the first terminal device to configure the first terminal device to use dual connectivity with the first radio access node and the second radio access node.

6. A method as defined in statement 5, wherein the second signal is a radio resource control, RRC, Connection message.

7. A method as defined in any of statements 1-6, wherein the method further comprises:
in the event that it is determined that dual connectivity with the first RAT and the second RAT for the first terminal device is not to be activated, determining modified capability information for the first terminal device indicating that the first terminal device is not capable of using dual connectivity with the first RAT and the second RAT; and
storing the modified capability information in the first radio access node.

8. A method as defined in any of statements 1-7, wherein the first radio access node receives the capability information from the first terminal device.

9. A method as defined in any of statements 1-7, wherein the first radio access node receives the capability information during an attachment procedure in which the first terminal device attaches to the first radio access node.

10. A method as defined in statement 9, wherein the first radio access node receives the capability information from the first terminal device in a UE-EUTRA-Capability field.

11. A method as defined in any of statements 1-10, wherein the method further comprises the step of:
sending the capability information to a core network node.

12. A method as defined in any of statements 1-7, wherein the first radio access node receives the capability information from a core network node.

13. A method as defined in any of statements 1-12, wherein the first radio access node receives the permission information from another network node.

14. A method as defined in statement 13, wherein the first radio access node receives the permission information in one or more of an Initial Context Setup Request message, a UE Context Modification Request message, a Handover Request message and a Downlink NAS Transport message.

15. A method as defined in any of statements 1-14, wherein the permission information is contained in a list that indicates one or more parameters or restrictions for the first terminal device.

16. A method as defined in statement 15, wherein the list is a Handover Restriction List, HRL.

17. A method as defined in statement 14, wherein the permission information is contained in an information element, IE.

18. A method as defined in statement 14, wherein the permission information is contained in a Subscriber Profile ID, SPID information element, IE.

19. A method as defined in any of statements 14-18, wherein the another network node is a core network node and the permission information is received during an attachment procedure in which the first terminal device attaches to the core network node.

20. A method as defined in any of statements 14-19, wherein the another network node is a third radio access node that uses the first RAT and the permission information is received during handover of the first terminal device from the third radio access node to the first radio access node.

21. A method as defined in any of statements 1-20, the method further comprising the step of:
sending the permission information and/or the capability information to a fourth radio access node that uses the first RAT on or during handover of the first terminal device from the first radio access node to the fourth radio access node.

22. A method of operating a core network node, wherein the method comprises:
receiving permission information from an information database, the permission information indicating whether a first terminal device is permitted to use dual connectivity with a first radio access technology, RAT, and a second, different, RAT; and
sending the permission information to a first radio access node that uses the first RAT.

23. A method as defined in statement 22, wherein the permission information is sent to the first radio access node in a list that indicates one or more parameters or restrictions for the first terminal device.

24. A method as defined in statement 23, wherein the list is a Handover Restriction List, HRL.

25. A method as defined in statement 22, wherein the permission information is sent to the first radio access node in an information element, IE.

26. A method as defined in statement 22, wherein the permission information is sent to the first radio access node in a Subscriber Profile ID, SPID information element, IE.

27. A method as defined in statement 22, wherein the permission information is sent to the first radio access node in an Initial Context Setup Request message, a UE Context Modification Request message, a Downlink NAS Transport message or in a Handover Request message.

28. A method as defined in any of statements 22-27, wherein the permission information is sent to the first radio access node during an attachment procedure in which the first terminal device attaches to the core network node.

29. A method as defined in any of statements 22-28, wherein the information database is a Home Subscriber Server, HSS.

30. A method as defined in any of statements 22-29, wherein the method further comprises the step of:
receiving capability information for the first terminal device from the first radio access node, the capability information indicating whether the first terminal device is capable of using dual connectivity with the first RAT and the second RAT.

31. A method as defined in statement 30, wherein the capability information is contained in a UE Radio Capability Information Element, IE.

32. A method as defined in any of statements 22-31, wherein the method further comprises the step of:
sending capability information for the first terminal device to the first radio access node, the capability information indicating whether the first terminal device is capable of using dual connectivity with the first RAT and the second RAT.

33. A method as defined in any of statements 22-32, wherein the core network node is a mobility management entity, MME, a mobility management function, MMF or an access and mobility management function, AMF.

34. A method of operating an information database, the method comprising:
storing permission information for at least a first terminal device, the permission information indicating whether a first terminal device is permitted to use dual connectivity with a first radio access technology, RAT, and a second, different, RAT; and
sending the permission information to a core network node.

35. A method as defined in statement 34, wherein the permission information is set based on a subscription for the first terminal device or based on a network operator preference.

36. A method as defined in any of statements 1-35, wherein the first RAT is Long Term Evolution, LTE.

37. A method as defined in any of statements 1-36, wherein the second RAT is a 5^{th} Generation, 5G, or New Radio, NR, RAT.

38. A first radio access node, the first radio access node using a first radio access technology, RAT, to communicate with terminal devices; the first radio access node being adapted or configured to:
receive capability information for a first terminal device, the capability information indicating whether the first terminal device is capable of using dual connectivity with the first RAT and a second, different, RAT;
receive permission information, the permission information indicating whether the first terminal device is permitted to use dual connectivity with the first RAT and the second RAT; and
determine whether to activate dual connectivity with the first RAT and the second RAT for the first terminal device based on the received capability information and received permission information.

Further embodiments of the first radio access node are contemplated in which the first radio access node is adapted or configured to operate according to any of statements 2-21.

39. A core network node, the core network node being adapted or configured to:
receive permission information from an information database, the permission information indicating whether a first terminal device is permitted to use dual connectivity with a first radio access technology, RAT, and a second, different, RAT; and
send the permission information to a first radio access node that uses the first RAT.

Further embodiments of the core network node are contemplated in which the core network node is adapted or configured to operate according to any of statements 23-33.

40. An information database, the information database being adapted or configured to:
store permission information for at least a first terminal device, the permission information indicating whether a first terminal device is permitted to use dual connectivity with a first radio access technology, RAT, and a second, different, RAT; and
send the permission information to a core network node.

Further embodiments of the information database are contemplated in which the information database is adapted or configured to operate according to statement 35.

41. A computer program product comprising a computer readable medium having computer readable code embodied therein, the computer readable code being configured such that, on execution by a suitable computer or processor, the computer or processor is caused to perform the method of any of statements 1-37.

1-49. (canceled)

50. A method of operating a first radio access node, wherein the first radio access node uses a first radio access technology (RAT) to communicate with terminal devices, wherein the method comprises:
receiving capability information for a first terminal device, the capability information indicating whether the first terminal device is capable of using dual connectivity with the first RAT and a second, different, RAT;
receiving permission information, the permission information indicating whether the first terminal device is permitted to use dual connectivity with the first RAT and the second RAT; and
determining whether to activate dual connectivity with the first RAT and the second RAT for the first terminal device based on the received capability information and received permission information.

51. A non-transitory computer-readable medium having computer readable code embodied therein, the computer readable code being configured such that, on execution by a suitable computer or processor, the computer or processor is caused to perform the method of claim 50.

52. A method of operating a core network node, wherein the method comprises:
receiving permission information from an information database, the permission information indicating whether a first terminal device is permitted to use dual connectivity with a first radio access technology (RAT) and a second, different, RAT; and
sending the permission information to a first radio access node that uses the first RAT.

53. A method of operating an information database, the method comprising:
storing permission information for at least a first terminal device, the permission information indicating whether a first terminal device is permitted to use dual connectivity with a first radio access technology (RAT) and a second, different, RAT; and
sending the permission information to a core network node.

54. A first radio access node, configured to use a first radio access technology (RAT) to communicate with terminal devices, the first radio access node comprising:
a processor; and
a memory, said memory containing instructions executable by said processor whereby said first radio access node is operative to:
receive capability information for a first terminal device, the capability information indicating whether the first terminal device is capable of using dual connectivity with the first RAT and a second, different, RAT;
receive permission information, the permission information indicating whether the first terminal device is permitted to use dual connectivity with the first RAT and the second RAT; and
determine whether to activate dual connectivity with the first RAT and the second RAT for the first terminal device based on the received capability information and received permission information.

55. The first radio access node of claim 54, wherein the first radio access node is operative to determine whether to activate dual connectivity with the first RAT and the second RAT for the first terminal device by:
determining to activate dual connectivity with the first RAT and the second RAT for the first terminal device in the event that the received capability information indicates that the first terminal device is capable of using dual connectivity with the first RAT and the second RAT and the received permission information indicates that the first terminal device is permitted to use dual connectivity with the first RAT and the second RAT; and
otherwise determining that dual connectivity with the first RAT and the second RAT for the first terminal device is not to be activated.

56. The first radio access node of claim 54, wherein the first radio access node is further operative to:
send a first signal to a second radio access node that uses the second RAT to configure the second radio access node to communicate with the first terminal device in the event that dual connectivity with the first RAT and the second RAT for the first terminal device is to be activated.

57. The first radio access node of claim 54, wherein the first radio access node is further operative to:
send a second signal to the first terminal device to configure the first terminal device to use dual connectivity with the first radio access node and the second radio access node in the event that dual connectivity with the first RAT and the second RAT for the first terminal device is to be activated.

58. The first radio access node of claim 54, wherein the first radio access node receives the capability information from the first terminal device.

59. The first radio access node of claim 54, wherein the first radio access node is operative to receive the capability information during an attachment procedure in which the first terminal device attaches to the first radio access node.

60. The first radio access node of claim 54, wherein the first radio access node is operative to receive the permission information from another network node.

61. The first radio access node of claim 60, wherein the first radio access node is operative to receive the permission information in one or more of an Initial Context Setup Request message, a UE Context Modification Request message, a Handover Request message and a Downlink NAS Transport message.

62. The first radio access node of claim 54, wherein the permission information is contained in a list that indicates one or more parameters or restrictions for the first terminal device.

63. A The first radio access node of claim 62, wherein the list is a Handover Restriction List (HRL).

64. The first radio access node of claim 61, wherein the another network node is a core network node and the permission information is received during an attachment procedure in which the first terminal device attaches to the core network node.

65. The first radio access node of claim 61, wherein the another network node is a third radio access node that uses the first RAT and the permission information is received during handover of the first terminal device from the third radio access node to the first radio access node.

66. A core network node, comprising:
a processor; and
a memory, said memory containing instructions executable by said processor whereby said core network node is operative to:
receive permission information from an information database, the permission information indicating whether a first terminal device is permitted to use dual connectivity with a first radio access technology (RAT) and a second, different, RAT; and
send the permission information to a first radio access node that uses the first RAT.

67. The core network node of claim 66, wherein the permission information is sent to the first radio access node in a list that indicates one or more parameters or restrictions for the first terminal device.

68. The core network node of claim 66, wherein the list is a Handover Restriction List (HRL).
